(19) United States
(12) Patent Application Publication
(10) Pub. No.: US 2007/0097089 A1
(43) Pub. Date: May 3, 2007

(54) Imaging device control using touch pad

(76) Inventor: Amy E. Battles, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/263,422

(22) Filed: Oct. 31, 2005

(51) Int. Cl. G09G 5/00

(52) U.S. Cl. 345/173

(57) ABSTRACT

An exemplary method for controlling an electronic imaging device may include detecting a sweeping motion on a touch pad, and adjusting a setting on the electronic imaging device in response to the sweeping motion.

U.S. patent application Ser. No. ______, of Amy E. Battles (attorney docket no. 200506143-1), filed on the same day as this application, U.S. patent application Ser. No. ______, of Amy E. Battles (attorney docket no. 200506124-1), filed on the same day as this application, U.S. patent application Ser. No. ______, of Amy E. Battles, Daniel J. Byrne, Shanshan Li and Norman C. Pyle (attorney docket no. 200506156-1) filed on the same day as this application, U.S. patent application Ser. No. ______, of Amy E. Battles, Shanshan Li and Norman C. Pyle (attorney docket no. 200506158-1) filed on the same day as this application and U.S. patent application Ser. No. ______, of Mark J. Bianchi, Norman C. Pyle, Amy E. Battles, Shanshan Li and Daniel J. Byrne, (attorney docket no. 200506123-1) filed on the same day as this application, are all hereby incorporated by reference for all that is disclosed therein.

### BACKGROUND

Electronic imaging devices such as digital cameras are used in a wide range of applications and are steadily becoming less expensive and simpler to use. Electronic images may be stored indefinitely without the image degradation suffered by film-based images. Electronic imaging devices generate images that can be viewed immediately and used in a variety of ways such as printing, posting to a web page on the World Wide Web, transmitting to others by electronic mail or other means, etc. They can also rapidly capture large numbers of images that can be previewed and stored or deleted as desired.

Electronic imaging devices typically include many settings that can be manually adjusted, such as focus and exposure settings. However, the interfaces enabling a user to adjust these settings can be complex, expensive and difficult to use.

### BRIEF DESCRIPTION OF THE DRAWINGS

Illustrative embodiments are shown in the accompanying drawings as described below.

FIG. 1 is an isometric front view illustration of an exemplary electronic imaging device.

FIG. 2 is an isometric rear view illustration of the exemplary electronic imaging device of FIG. 1.

FIG. 3 is a block diagram of an exemplary embodiment of an electronic imaging device.

FIG. 4 is a flow chart of an exemplary operation for controlling an electronic imaging device using a touch pad with tap points.

FIGS. 5A-5D are rear elevation views of an exemplary electronic imaging device having various exemplary touch pad configurations.

### DESCRIPTION

The drawing and description, in general, disclose an electronic imaging device having a scrolling touch pad by which settings may be adjusted. In one exemplary embodiment, an electronic imaging device such as a digital camera or video camera may be used to capture and review or play back images under the control of the touch pad and other user inputs, if any. The term “electronic imaging device” is used herein to refer to an electronic device that can capture images. The scrolling touch pad may have any shape, such as circular for a rotary touch pad or elongated and rectangular for a linear touch pad. As the user strokes the touch pad, an associated setting in the electronic imaging device scrolls through its range of states. For example, if the touch pad is configured to adjust manual focus, when a finger or stylus is moved across the touch pad, the manual focus will be adjusted from a closeup to an infinite focus state or vice versa, depending on the direction of the stroke. The length of the stroke on the touch pad controls the range of states through which the setting is adjusted. A short stroke will change the setting only slightly, while a longer stroke can be used to move through the entire available range for the setting. The touch pad control may be tuned or calibrated so that each stroke steps through an appropriate number of setting states so that users can reach a desired setting state with precision without having to perform excessively long or numerous strokes on the touch pad to scroll through the range of states.

The scrolling touch pad may be used to control a variety of settings on the electronic imaging device by selecting the feature controlled by the touch pad. In this embodiment, a mechanism is provided for toggling or changing the feature, such as an arrow key adjacent the touch pad. A list of settings that may be adjusted by the touch pad in any given mode or state may be displayed on a display panel, enabling the user to move through the list in menu fashion to select the desired setting and to view the current state of the setting as the touch pad is used to scroll through the range of states. The touch pad and other controls such as arrow keys may be dedicated for use in adjusting a particular setting or group of settings, or may also be used for other tasks in the user interface for the electronic imaging device.

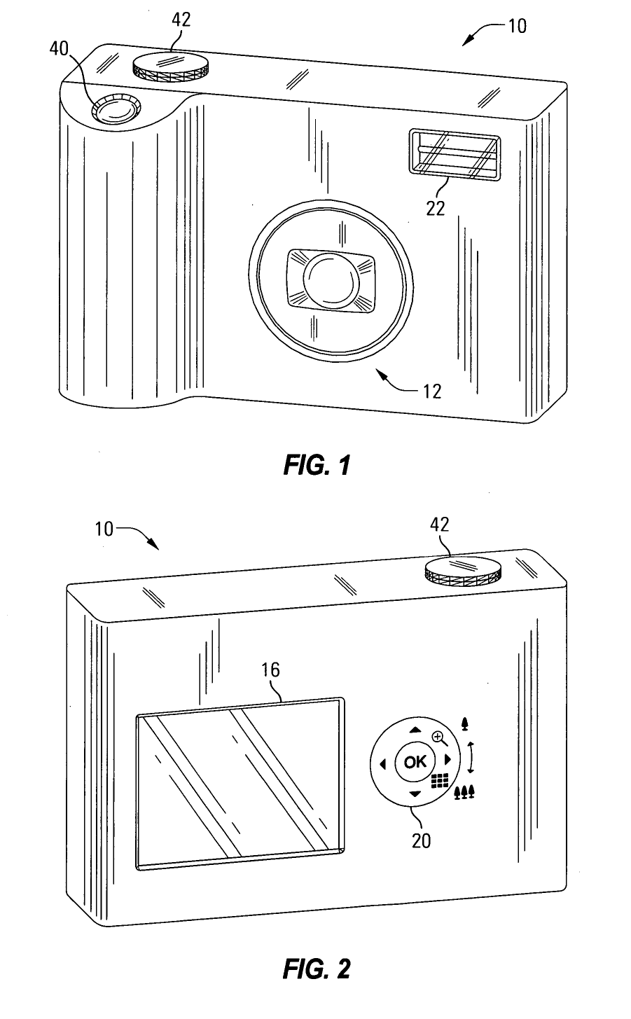

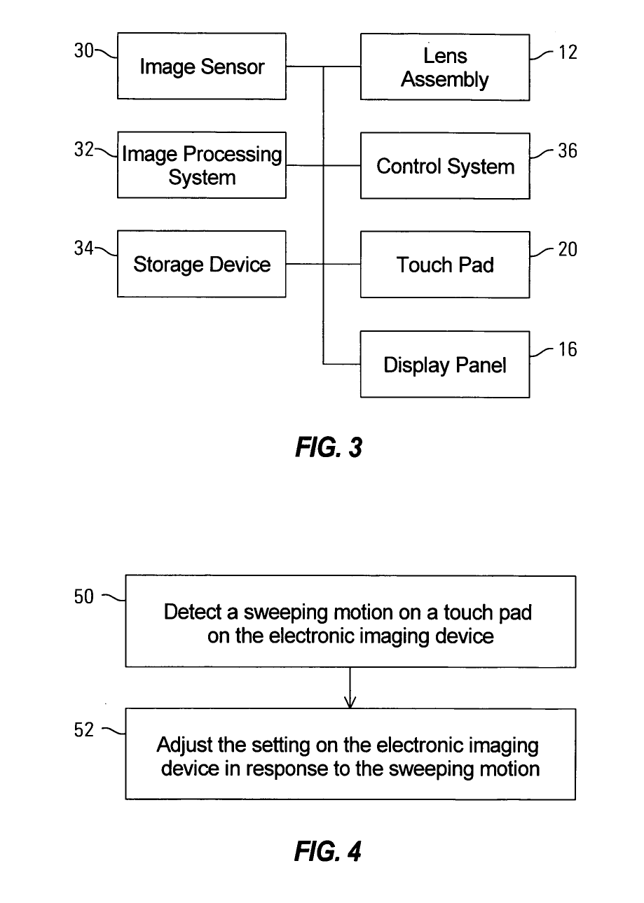

Before continuing to describe the scrolling touch pad in more detail, an exemplary digital camera 10 (FIGS. 1-3) which may employ a scrolling touch pad will be described. However, it is important to note that the scrolling touch pad is not limited to any particular type of electronic imaging device, and the digital camera 10 discussed herein is purely exemplary. The digital camera 10 includes a lens assembly 12, display panel 16, touch pad 20, and flash 22. The digital camera also includes an image sensor 30, an image processing system 32 to process and format the image data, and a storage device 34 to store the image data collected by the image sensor 30. A user interface is implemented in the digital camera 10 by a control system 36, including accepting user input via the scrolling touch pad 20 and other inputs such as a shutter control button 40, and controlling the settings and functions of the digital camera 10. A mode dial 42 may be included to control various functions of the digital camera 10, such as power on/off and mode select including playback or image capture. Alternatively, these types of functions may be controlled in any suitable manner, such as with other switches or buttons or using a menu system. The digital camera 10 may also include a power source such as a battery. Each of the foregoing exemplary systems and devices will now be described.

Image light enters the digital camera 10 through the lens assembly 12. The image sensor 30, a charge-coupled device (CCD) or other image sensor, detects the image light focused thereon by the lens assembly 12. A typical CCD comprises an array of individual cells or pixels, each of which collects or builds-up an electrical charge in response to exposure to light. Because the quantity of the accumulated electrical charge in any given cell or pixel is related to the intensity and duration of the light exposure, a CCD may be used to detect light and dark spots in an image focused thereon.

The term image light as used herein refers to the light, visible or otherwise, that is focused onto the surface of the image sensor 30 by the lens assembly 12. The image light may be converted into digital image data in essentially three steps. First, each pixel in the CCD detector converts the light it receives into an electric charge. Second, the charges from the pixels are converted into analog voltages by an analog amplifier. Finally, the analog voltages are digitized by an analog-to-digital (A/D) converter, generating numeric representations of the amplitudes of the analog voltages. The digital image data then may be processed and/or stored as desired.

The image processing system 32 processes and formats the image data, either before or after storage in the storage device 34. The image processing system 32 comprises a microprocessor and associated memory. Alternatively, the image processing system 32 may comprise a hard-coded device such as an application specific integrated circuit (ASIC), or some combination of these devices. The storage device 34 stores the image data collected by the image sensor 30. The storage device 34 comprises a removable rewriteable non-volatile memory such as a flash media card, or may comprise a random access memory (RAM), or a magnetic, optical, or other solid state storage medium.

The display panel 16 comprises a liquid crystal display (LCD) or any other suitable display device and is used to display a live view of the subject in capture mode, or to display thumbnails or stored images in playback mode, as well as menus, status information, etc.

The control system 36 may comprise a microprocessor and associated firmware or software to provide a user interface and to control the digital camera 10. The control system 36 and image processing system 32 may share a single microprocessor, or may each have a dedicated microprocessor. Alternatively, the control system 36 may comprise a hard-coded device such as an application specific integrated circuit (ASIC), or some combination of these devices.

The digital camera 10 may also include other components, such as an audio system. However, because digital cameras are well-known in the art and could be provided by persons having ordinary skill in the art after having become familiar with the teachings of the present disclosure, the digital camera 10 utilized in one embodiment, as well as the various ancillary systems and devices (e.g., battery systems and storage devices) that may be utilized in one embodiment will not be described in further detail herein.

During operation of the digital camera 10, the digital camera 10 is turned on and placed in image capture mode using one or more control inputs such as the mode dial 42. The digital camera 10 is oriented with the lens assembly 12 directed at a subject. A live view of the subject may be monitored on the display panel 16. The lens assembly 12 is focused on the subject, either automatically or manually using the scrolling touch pad, and zoomed to the desired focal length using the scrolling touch pad. When the digital camera 10 is properly oriented and focused, the shutter control button 40 is pressed. The flash 22 illuminates the subject, if needed. The image sensor 30 converts the image light directed thereon by the lens assembly 12 into electrical image data. The image processing system 32 processes the image data, displays the captured image on the display panel 16 and stores the image data in one or more files on the storage device 34. The digital camera 10 may also be placed in playback mode using one or more control inputs such as the mode dial 42. The touch pad 20 may be used to scroll through images stored on the storage device 34, either one by one in single image full screen view on the display panel 16 or by navigating or scrolling through an array of thumbnail images displayed on the display panel 16. Images in full screen view may be magnified or zoomed and panned to select the magnified image portion to display.

The scrolling touch pad 20 may be used to control these various features, such as manual focus, zoom, aperture and shutter speed in capture mode, or image selection, magnification and panning in playback mode. The feature being controlled by the touch pad 20 may be selected using a control input such as arrow keys, either independent or integrated in the touch pad. The available settings that may be adjusted by the touch pad 20 may vary based on the current state of the electronic imaging device, such as the mode (capture or playback) or the display state (full screen view versus thumbnail array, zoomed or full image, etc.). An exemplary operation for controlling an electronic imaging device using a touch pad 20 is summarized in the flow chart of FIG. 4. When a sweeping motion across the touch pad is detected 50, a setting on the electronic imaging device is scrolled or adjusted 52 in response.

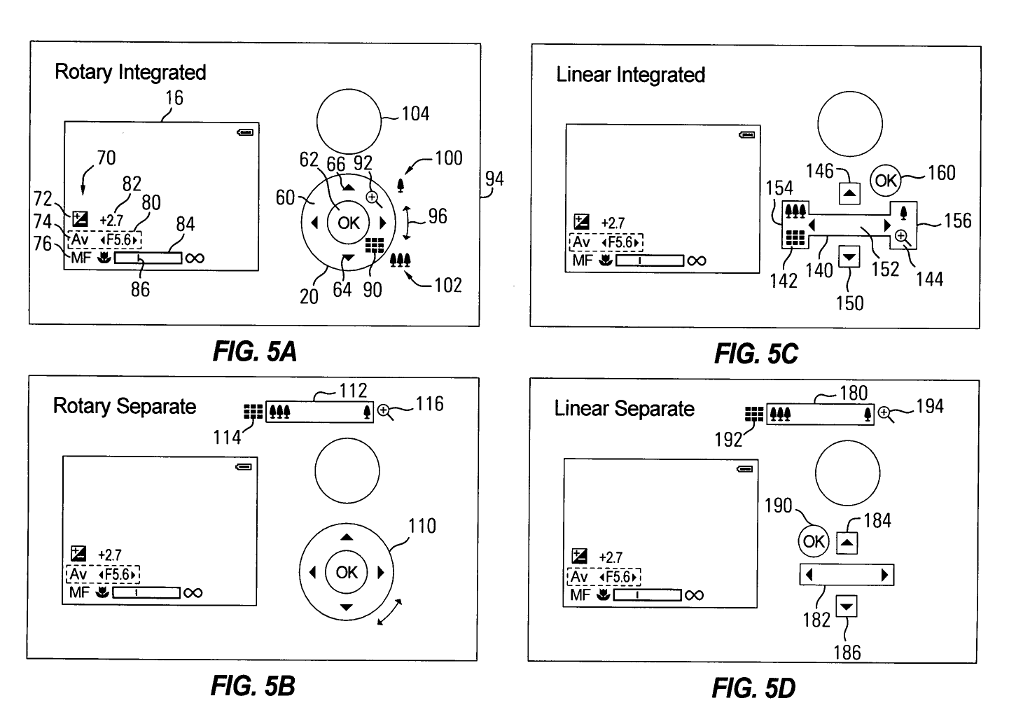

Referring to FIG. 5A, an exemplary embodiment of a multifunction rotary touch pad 20 with integrated arrow keys and its use in controlling an electronic imaging device will now be described in more detail. In this exemplary embodiment, the control of both capture mode settings and playback mode settings is integrated into the rotary touch pad 20. The touch pad 20 has a surface that may comprise any device sensitive to touch that is now known or that may be developed in the future. For example, the touch pad 20 may be sensitive to pressure against its surface, or may detect the proximity of an object in any manner. Furthermore, the touch pad 20 may be adapted to detect a proximate object without physical contact between the object and the touch pad 20 if desired. The touch pad 20 may be activated by any suitable object, such as a user's finger, a stylus, etc. The touch pad 20 may comprise a single touch sensitive surface in any desired shape or configuration, or may comprise a plurality of active elements that act in combination to form the touch sensitive surface for the touch pad 20. The touch pad 20 may have one or more outputs connected to the control system 36 enabling it to detect and identify various types of activation events, such as a sweeping movement of an object over or adjacent the touch pad 20, or a tapping or approach by an object substantially in a single region of the touch pad 20 without significant lateral movement across the touch pad 20.

The exemplary touch pad 20 illustrated in FIG. 5 is a rotary touch pad having an annular region 60 surrounding a circular center button region 62. The annular region 60 and circular center button region 62 may be formed as a single integral touch sensitive surface, or may be formed by two or more separate contiguous elements. An annular inactive region may also be provided around the circular center button region 62 to provide isolation between the annular region 60 and the circular center button region 62 if desired. The touch sensitive surface of the touch pad 20 may be formed in the circular or annular shape, or may have a rectangular or other shape with a circular window or template over the touch sensitive surface to define the outer perimeter of the annular shape.

Settings may be adjusted in the electronic imaging device by stroking the touch pad 20 in a sweeping motion, dragging a finger or thumb or other object along or adjacent the touch sensitive surface of the touch pad 20. The direction and path of the sweeping motion are dependent upon the configuration of the touch pad 20 and the desired setting change. For example, with a rotary touch pad 20 such as that illustrated in FIG. 5A, the sweeping motion would be a circular motion around the annular region 60. To make a slight adjustment to a setting, the sweeping motion could be a short arc along the annular region 60. To make a larger adjustment to the setting, the sweeping motion could continue around and around the annular region 60 as needed to reach the desired state. As the sweeping motion continues, the setting scrolls through its range of available states until a boundary state value is reached, such as the largest focal length available for the lens on the electronic imaging device. The touch pad 20 may be tuned or calibrated so that each stroke steps through an appropriate number of setting states so that users can reach a desired setting state with precision without having to perform excessively long or numerous strokes on the touch pad to scroll through the range of states. The length of a stroke on a rotary touch pad would be measured in non-linear fashion following the curvilinear path of the stroke.

The exemplary touch pad 20 includes integrated arrow keys (e.g., 64 and 66) that may be tapped to select a different feature to be scrolled or adjusted by the touch pad 20. A list 70 of settings that may be adjusted by the touch pad 20 based on the current state of the electronic imaging device may be displayed on a display panel 16. For example, in an image capture mode, the list 70 may contain exposure compensation 72, aperture 74 and manual focus 76 settings. The setting currently associated with the touch pad 20 may be highlighted 80, and as up or down arrow keys 66 and 64 are pressed, other settings are selected and the highlight moves in the list 70. The current state of each setting may also be displayed (e.g., 82 and 84) and updated as the touch pad 20 is used to scroll through the range of available states. For example, an indicator bar 86 in a status bar 84 may be moved from left to right to indicate the manual focus setting as it is focused out to a more distant subject. The arrow keys (e.g., 64 and 66) and circular center button region 62 may also be used to navigate through menus in the user interface and to select menu items or confirm commands.

The exemplary touch pad 20 also includes two tap points 90 and 92 that may be tapped to change the feature that is controlled by the touch pad 20. Any desired number of tap points may be included on the touch pad 20 to enable the user to select different features or modes for the touch pad 20. For example, a menu tap point may also be provided to call up a menu on the display panel 16. The tap points (e.g., 90 and 92) may located in any desired region of the touch pad 20. For example, the two exemplary tap points 90 and 92 are located in the lower right and upper right regions of the touch pad 20, placing them closest to a right side 94 of the electronic imaging device for convenient access to a users thumb. Note that the arrow keys (e.g., 64 and 66) and tap points 64 and 66 also form part of the scrolling touch pad 20, so that sweeping movements may be detected as they pass over the tap points 90 and 92. Contact on the tap points 90 and 92 only alters the function of the touch pad 20 when they are tapped without significant lateral motion. The tap points 90 and 92 may be sized and shaped as desired. As the tap points are used to select a different setting to be adjusted, the settings list 70 on the display panel 16 may also be updated to indicate the currently selected setting.

Icon or graphics may be printed or displayed on the touch pad 20 as desired to clarify the use of the touch pad 20. For example, arrows may be printed in the regions of the arrow keys (e.g., 64 and 66), tap point icons such as an array or a magnifying glass may be provided in the regions of the tap points (e.g., 90 and 92), etc. The icons or graphics may be printed on or around the touch pad 20, or may be actively displayed using a touch sensitive display panel or backlighting using LEDs to illuminate icons formed of a translucent material in the touch pad. If the icons are actively displayed, they may change based on the state of the electronic imaging device if desired. Other graphics may be included on or near the touch pad 20. For example, an arcuate arrow icon 96 may be provided adjacent the touch pad 20 indicating the rotary nature of the touch pad 20, informing the user that a circular sweeping motion around the annular region 60 may be used to control features of the electronic imaging device, such as zooming in and out. Telephoto 100 and wide angle 102 icons may be provided at opposite ends of the arcuate arrow icon 96 indicating the directions to use for circular sweeping motions around the annular region 60 for a desired result. An inactive region 104 may also be provided on the back of the electronic imaging device, such as above the touch pad 20, so that the user can rest a thumb in the inactive region 104 to support the electronic imaging device without inadvertently manipulating the user interface.

Exemplary features of an electronic imaging device that may be controlled by a touch pad (e.g., 20) include the following:
Zoom
Focus Distance
Aperture
Shutter Speed
Exposure Compensation
Flash Setting
White Balance
Iso Speed
Contrast Setting
Saturation
Sharpness
Exposure Metering Region
Focus Zone
Shooting Mode
Scrolling Through Full Screen Images
Magnification of Image
Panning of Magnified Image
Scrolling Through Thumbnails of Images
Stepping Through Frames of a Video Clip
Rotating an Image
Adjusting the Size of a Border Applied to an Image
Adjusting the Color of a Tint Applied to an Image
Adjusting Any Variable of Artistic Effect Applied to an Image
Scrolling Through Menu Options
Adjusting Crop Box for Cropping an Image

The exemplary operation of the rotary touch pad 20 for controlling an electronic imaging device will now be discussed. However, it is important to note that the functionality of the touch pad 20 may be adapted as desired based on the user interface of the electronic imaging device, and the operation described herein is purely exemplary. As indicated above, the features or settings that may be adjusted by the touch pad 20 may vary depending on the state of the electronic imaging device. When the electronic imaging device is in a capture or live view mode, the touch pad 20 may default to controlling the zoom or focal length of the lens when the user rotates a finger around the annular region 60, for example using a counterclockwise motion to zoom in and a clockwise motion to zoom out. In this mode, a live view of the subject may be displayed on the display panel 16, and an indicating of the focal length may be added to the list 70 on the display panel 16 and highlighted. Alternatively, the live view of the subject on the display panel 16 may be used to determine when the desired focal length is reached without adding it to the list 70. In this embodiment, none of the settings in the list 70 would be highlighted when the touch pad 20 is used to control zoom. The arrow keys 64 and 66 or tap points 90 and 92 may be used to select a different setting to adjust, and the touch pad 20 may be used to configure all the settings to the desired states before capturing an image.

When the electronic imaging device is in a playback mode, the touch pad 20 may be used to scroll through stored images for display or deletion, or to zoom in and out on a stored image displayed on the display panel 16. In playback mode, the touch pad 20 may default to an image select mode in which the user rotates a finger around the annular region 60 to scroll through stored images, either one by one in a full screen view or by navigating in an array of thumbnails displayed on the display panel 16. The arrow keys 64 and 66 or tap points 90 and 92 may be used to select various settings or functions to control with the touch pad 20, such as selecting an image, zooming and panning the image, or editing the image, such as cropping, rotating, or adjusting the color. The list 70 may be updated with the settings that are available for control by the touch pad 20, such as the types of image editing operations that can be controlled by the touch pad 20.

Referring now to FIG. 5B, another exemplary embodiment includes two scrolling touch pads, a rotary touch pad 110 and a linear touch pad 112. In this embodiment, features or settings may be allocated as desired to the two touch pads 110 and 112. For example, one can be used for capture mode settings and the other for playback mode settings, or the linear touch pad 112 may be used for zooming in capture mode and magnifying images in playback mode while the rotary touch pad 110 may be used to adjust all other settings, navigate through menus, edit images, etc. Tap points may be provided either inside or outside of the scroll regions of the touch pads. For example, two tap points 114 and 116 are provided just outside the ends of the scroll region of the linear touch pad 112 to select different features to control. The touch sensitive surface for the scroll region of the linear touch pad 112 and the tap points 114 and 116 may be formed of a single element or multiple elements, as desired.

Referring now to FIG. 5C, another exemplary embodiment may comprise an elongated or “dumbbell” shaped linear touch pad 140. Tap points 142 and 144 and arrow keys 146 and 150 may be provided to select the feature to be controlled by the touch pad 140. This touch pad 140 and the associated tap points 142 and 144 and arrow keys 146 and 150 operates in substantially the same manner as described above with respect to the rotary touch pad 20, except that sweeping motions across the touch pad 140 to scroll a feature of the electronic imaging device are substantially linear, moving back and forth across a scroll strip region 152 rather than around the annular region 60 of the rotary touch pad 20. The exemplary thumbnail array tap point 142 is provided at the left side 154 of the touch pad 140 and a magnifying glass tap point 144 is provided at the right side 156 of the touch pad 140. The tap points 142 and 144 may have any size and shape desired, such as a square, round, or the illustrated rectangular shape that is large enough to contain icons suggesting the feature associated with the tap point, thereby forming a “dumbbell” shaped touch pad 140 with the tap points 142 and 14 at the left and right sides 154 and 156 surrounding a central elongated linear scroll strip region 152. The arrow keys 146 and 150 and an “OK” button 160 may be used to toggle the functionality of the touch pad 140 or to perform other functions such as navigating through a menu or thumbnail array, selecting a menu item or image or confirming an operation.

Referring now to FIG. 5D, another exemplary embodiment includes two linear scrolling touch pads 180 and 182, along with arrow keys 184 and 186, an “OK” button 190, and tap points 192 and 194. In this embodiment, features or settings may be allocated as desired to the two touch pads 180 and 182. For example, one can be used for capture mode settings and the other for playback mode settings, or one 180 may be used for zooming in capture mode and magnifying images in playback mode while the other 182 may be used to adjust all other settings, navigate through menus, edit images, etc.

A scrolling touch pad greatly simplifies and optimizes the user interface of an electronic imaging device, allowing the user to quickly and easily scroll through settings.

While illustrative embodiments have been described in detail herein, it is to be understood that the concepts disclosed herein may be otherwise variously embodied and employed, and that the appended claims are intended to be construed to include such variations, except as limited by the prior art.

What is claimed is:

1. A method for controlling an electronic imaging device, the method comprising:
detecting a sweeping motion on a touch pad on said electronic imaging device; and
adjusting a setting on said electronic imaging device in response to said sweeping motion.

2. The method of claim 1, said touch pad comprising a scrolling touch pad, wherein adjusting said setting comprises scrolling through a range of states for said setting in a manner proportional to said sweeping motion.

3. The method of claim 2, wherein a rate of said scrolling is calibrated touch pad relative to a number of states in said range.

4. The method of claim 1, further comprising selecting a different setting to be adjusted by sweeping motions on said touch pad.

5. The method of claim 4, wherein said different setting to be adjusted is selected in response to an input event on a user interface of said electronic imaging device.

6. The method of claim 4, wherein said different setting to be adjusted is selected in response to a pressed arrow key on said electronic imaging device.

7. The method of claim 4, further comprising displaying on a display panel on said electronic imaging device a list of settings that may be adjusted by sweeping motions on said touch pad.

8. The method of claim 7, further comprising highlighting a current setting in said list that is actively adjustable by said touch pad.

9. The method of claim 7, further comprising displaying a current state of a current setting in said list that is actively adjustable by said touch pad and updating said displayed current state as said current setting is adjusted by sweeping motions on said touch pad.

10. The method of claim 1, wherein said setting comprises at least one member selected from the group consisting of zoom, focus distance, aperture, shutter speed, exposure compensation, flash setting, white balance, ISO speed, contrast setting, saturation, sharpness, exposure metering region, focus zone, and shooting mode.

11. The method of claim 1, wherein said setting comprises at least one member selected from the group consisting of scrolling through full screen images, magnification of images, panning of magnified images, scrolling through thumbnails of images, stepping through frames of a video clip, rotating an image, adjusting a size of a border applied to an image, adjusting a color of a tint applied to an image, adjusting any variable of artistic effect applied to an image, scrolling through menu options, and adjusting crop box for cropping an image.

12. The method of claim 1, wherein said touch pad comprises a rotary touch pad and said sweeping motion traces a curvilinear path.

13. The method of claim 1, wherein said touch pad comprises an elongated linear touch pad and said sweeping motion traces a substantially linear path.

14. A user interface for an electronic imaging device comprising:
a touch pad; and
a control system adapted to detect sweeping motions against said touch pad and to adjust a setting of said electronic imaging device in response to said sweeping motions.

15. The user interface of claim 14, said control system being further adapted to detect a setting type selection command and to associate a setting type with said touch pad so that sweeping motions against said touch pad adjust a setting designated by said setting type selection command.

16. The user interface of claim 14, said touch pad comprising a rotary touch pad having an annular touch sensitive region, wherein said sweeping motions comprise curvilinear strokes around said annular touch sensitive region.

17. The user interface of claim 14, said touch pad comprising an elongated linear touch pad, wherein said sweeping motions comprise substantially linear strokes.

18. The user interface of claim 14, wherein said setting comprises at least one member selected from the group consisting of zoom, focus distance, aperture, shutter speed, exposure compensation, flash setting, white balance, ISO speed, contrast setting, saturation, sharpness, exposure metering region, and focus zone.

19. The user interface of claim 14, wherein said setting comprises at least one member selected from the group consisting of scrolling through full screen images, magnification of images, panning of magnified images, scrolling through thumbnails of images, stepping through frames of a video clip, rotating an image, adjusting a size of a border applied to an image, adjusting a color of a tint applied to an image, adjusting any variable of artistic effect applied to an image, scrolling through menu options, and adjusting crop box for cropping an image.

20. An electronic imaging device, comprising:
means for entering a stroke input into said electronic imaging device; and
means for adjusting a setting of said electronic imaging device based on said stroke input.
